(19) United States
(12) Patent Application Publication
(10) Pub. No.: US 2014/0170270 A1
(43) Pub. Date: Jun. 19, 2014

(54) COMPOSITIONS

(71) Applicants: Fabio Campanile, Zollikerberg (CH); Rajesh Venkata Potineni, Cincinnati, OH (US); Aloysius Lambertus Doorn, Zeewolde (NL); Ruth Patrick, Dubendorf (CH)

(72) Inventors: Fabio Campanile, Zollikerberg (CH); Rajesh Venkata Potineni, Cincinnati, OH (US); Aloysius Lambertus Doorn, Zeewolde (NL); Ruth Patrick, Dubendorf (CH)

(73) Assignee: GIVAUDAN S.A., Vernier (CH)

(21) Appl. No.: 14/232,811

(22) PCT Filed: Jul. 20, 2012
(86) PCT No.: PCT/EP2012/064266

§ 371 Date: Jan. 14, 2014

Related U.S. Application Data
(60) Provisional application No. 61/509,851, filed on Jul. 20, 2011.

(51) Int. Cl. A23G 9/48

(52) U.S. Cl. CPC A23G 9/48
USPC 426/101; 426/302

(57) ABSTRACT

A frozen confectionary product including a particulate composition having a core containing a flavourant, flavour-enhancing ingredient, colourant or other beneficial ingredient, and one or more coatings around said core, wherein said coatings are gelatine, a fat or wax, ethyl cellulose or mixtures thereof.

The present disclosure is concerned with frozen confectionary products, in particular ice-cream, sorbets or confections having a high content of water as ice (water-ice), more particularly, the disclosure relates to said confections that contain a particulate composition to incorporate flavour or taste-enhancing ingredients, colourants or other beneficial ingredients into said confections.

Particulate compositions that incorporate flavour and taste-enhancing properties to consumable products are known in the art. They have a variety of uses: They may employed to separate encapsulated ingredients from the confectionary base to avoid any instability or incompatibility issues that otherwise might arise were they in simple admixture; they may be used to control the release of flavour from the consumable products to achieve desirable flavour effects; or they may be used to introduce attractive and/or functional colourant effects into said products.

Incorporation of such particulate compositions into frozen confectionary products can present particular problems for formulators. Typically, during the preparation of frozen confections particulate compositions can be subjected to extremes of temperature as a result of pasteurisation and freezing steps, as well being subjected to high shear forces experienced in mixing and extrusion steps. It is important that during manufacture, transportation and storage, ingredients contained in the particulate compositions remain so, particularly when those ingredients containing colourants, and do not prematurely leak into the surrounding frozen confectionary product.

There remains a need to provide particulate compositions that can be incorporated into frozen confections and stored therein over the life of the products without unacceptable leakage of flavourant, colourant or any other encapsulated beneficial ingredients.

In a first aspect there is provided a frozen confectionary product comprising a particulate composition comprising a core containing a flavourant, flavour-enhancing agent ingredient, colourant or other beneficial ingredient, and one or more coatings around said core, wherein said coatings comprise gelatine, a fat or wax, ethyl cellulose or mixtures thereof.

In accordance with the present embodiments, gelatine of any type and grade may suitably be used, including for example gelatine derived from bone or skin, in certain embodiments from bone. Modified gelatines including e. g. gelatine metaphosphates, hardened gelatine (e. g. those treated with a cross-linking agent such as formaldehyde), heat-treated gelatines and others may also be employed. The Bloom strength of the gelatine that is used may vary widely and may suitably range from 0-300, especially 10-300.

In accordance with the present embodiments the fat or wax used in a coating may have a melting point such that it softens or melts in the mouth, e.g. around 30 to 35 degrees centigrade. The fat is a lipophilic fatty acid residue containing materials such as triglycerides, diglycerides, monoglycerides, phosphatides and sucrose fatty acid polyesters. In particular, the fats may be triglycerides. More particularly still, the fat may be fully saturate palm oil, palm kernel oil, coconut oil. The wax may be carnuba wax.

Any type or grade of ethyl cellulose useful in the preparation of films or coatings may be employed in the present embodiments.

Coatings may contain other optional excipients that are typically included in capsule coatings including fillers, plasticizers, extenders and the like.

The level of coating material may vary anywhere from 0.5 to about 50% by weight based on the total particulate composition. More particularly, when the coating comprises ethyl cellulose it is typical to employ 1 to 30% by weight of that material in the coating, more particularly 3.5 to 30%, still more particularly 5 to 20%, still more particularly 5 to 10 wt %. When the coating contains fat or wax, it is typical to employ 0.5 to 50% by weight of that material, more particularly 15 to 30%, still more particularly 20 to 30 wt %. When the coating contains gelatine, typical to employ 0.5 to 50% by weight of that material, more particularly 15 to 30%, still more particularly 20 to 30 wt %.

As stated hereinabove, the particulate composition may contain one or more coatings and each coating may contain one or more of gelatine, ethyl cellulose and fat or wax.

The coating may be applied to a core containing beneficial ingredients that are desired to be encapsulated such as flavourants. Flavourants are well-known in the art and are mentioned, e. g., in S. Arctander, Perfume and Flavor Materials of Natural Origin (Elisabeth, N.J., USA, 1996), in T. E. Furia et al, CRC Fenaroli's Handbook of Flavor Ingredients, 2nd Ed. (Cleveland, CRC Press Inc., 1975), and in H. B. Heath, Source Book of Flavours (The Avi Publishing Company Inc., Westport, Conn., 1981).

The cores may also comprise colourants, acidulants, such as citric acid, coolants, sweeteners, taste enhancers such as sweetness enhancers, neutraceuticals, vitamins or any other beneficial agents whatsoever appropriate for use in frozen confectionary products.

The cores may be in the form of spray dried particles. For example, a spray dried particle may be formed by preparing a solution of suitable carbohydrate matrix-forming materials; incorporating flavourant, colourant or other beneficial agents in said solution and spray drying the solution according to techniques known in the art. A particular type of spray-dried particle and its method of preparation are described in WO 01/35764, which is hereby incorporated by reference in its entirety.

Alternatively, the cores may be in the form of microparticles as described in European patent application No. 1 064 856, which is likewise hereby incorporated by reference in its entirety.

In yet another alternative embodiment, the cores may be provided in the form of a granulate consisting of a grain of material such as an acidulent, e.g. citric acid, or a sugar is over-coated with a layer containing a flavourant, colourant or other beneficial agent. Such granulate materials are described in U.S. Pat. No. 6,056,949, which is hereby incorporated by reference in its entirety.

In still another alternative embodiment, a core may comprise an inert core that is over-coated with a flavour, colourant or beneficial agent-containing matrix material as described in EP 1,214,892, which is hereby incorporated by reference in its entirety.

The particulate compositions described herein can be produced by any suitable process, according to which a coating is fixed on core particles. The skilled person is well aware of such processes and it is unnecessary to go into great detail herein, other than to say that in particular, the compositions can be formed by means of a fluidised bed process. The coating may be applied e.g. by spraying a solution, emulsion or melt of the coating material onto the formed cores.

The size of the particles of the particulate composition may have a volume weighted average diameter of at least 50 microns, more particularly the average diameter is at least 80 microns, still more particularly at least 125 microns, more particularly still, the aforementioned average diameter will not exceed 1500 microns.

The bulk density of the particulate composition is typically within the range of 300-700 g/1. More particularly, the bulk density of the present composition is within the range of 400-600 g/1.

The particulate compositions used in frozen confectionary products according to the present embodiments are sufficiently robust to entrap in a stable manner the beneficial ingredients during manufacturing, transportation and storage operations, and yet release those beneficial agents at a desired rate when required. Release may be affected by diffusion, or it might occur as a result from exogenous stimulus acting on the compositions. For example, release might be affected by a consumer chewing or swallowing a confectionary product, or it might be affected by warming, resulting in softening or melting of the coating when the confectionary product is placed in the mouth.

A variety of release effects can be achieved by varying the type and weight of the coating material. Ethyl cellulose, for example, forms a particularly robust coating material. At relatively low coating weight, e.g. from about 1 to 10 wt % of the total weight of the composition, more particularly 3.5 to 10%, it provides for a durable particulate composition that is stable during manufacture, transportation and storage processes, but which also releases the entrapped beneficial agents when placed in the mouth of a consumer. Higher coating weights of ethyl cellulose may be employed, e.g., 15 to 20 wt % to deliver a slower release rate of the beneficial agent, or to add texture, e.g. it will create a crunchy texture, which can be desirable for some frozen confectionary products. The ethyl cellulose coatings can release the beneficial agents as a result of the application of crushing forces. This can provide an interesting flavour release effect in some frozen confectionary product applications.

Gelatine and fat or wax coatings tend to be softer and less robust than ethyl cellulose. As a result, compositions coated with these materials may release the beneficial agent at a faster rate than an ethyl cellulose-coated composition. Furthermore, the mechanism of release may be less dependent on crushing and more dependent on softening or melting of the coating, which again can offer a different type of release profile than that obtained using ethyl cellulose as a coating. As these coatings tend to be somewhat less robust than ethyl cellulose, one can employ a thicker coat weight, e.g. about 30% in order to ensure that the particulate compositions coated with these materials robustly retain beneficial agents during manufacturing, transport and storage.

The skilled person will appreciate from the foregoing that all manner of release effects can be achieved depending on the composition and weight of coating material employed to form the particulate compositions. It will also be apparent to the skilled person that release effects, such as sequential release effects, can be achieved if more than one population of particulate compositions having different coatings are employed in frozen confectionary products of the present embodiments.

The particular composition of the frozen confectionary product can influence the performance particulate compositions. For example, ice cream bases contain relatively low water content compared with water-ice or sorbet. If particulate compositions contain gelatine, fat or wax coatings, the coating weight is somewhat high when the compositions are employed in water-ice or sorbet, and relatively low when used in ice cream. Ethyl cellulose coated compositions on the other hand are relatively robust in all manner of frozen confectionary products, including those mentioned above and so relatively low coat weights may be employed, whilst retaining stability during manufacture, transportation and storage, and delivering excellent release performance.

In a particular embodiment there is provided an ice cream, water-ice or sorbet composition comprising a particulate composition comprising a core containing a flavourant, colourant or other beneficial agent mentioned hereinabove, and a coating surrounding said core comprising ethyl cellulose, the coating forming 1 to 15 wt %, more particularly 3.5 to 10 wt % based on the total weight of the composition.

In another particular embodiment there is provided an ice cream composition comprising a particulate composition comprising a core containing a flavourant, colourant or other beneficial agent mentioned hereinabove, and a coating surrounding said core comprising gelatine, the coating forming 15 to 50 wt % based on the total weight of the composition, more particularly 20 to 30 wt %.

In another particular embodiment there is provided a water-ice composition comprising a particulate composition comprising a core containing a flavourant, colourant or other beneficial agent mentioned hereinabove, and a coating surrounding said core comprising gelatine, the coating forming 20 to 30 wt % based on the total weight of the composition.

In another particular embodiment there is provided a sorbet composition comprising a particulate composition comprising a core containing a flavourant, colourant or other beneficial agent mentioned hereinabove, and a coating surrounding said core comprising gelatine, the coating forming 15 to 50 wt % based on the total weight of the composition, more particularly 20 to 30 wt %.

In another particular embodiment there is provided an ice cream composition comprising a particulate composition comprising a core containing a flavourant, colourant or other beneficial agent mentioned hereinabove, and a coating surrounding said core comprising a fat or wax, the coating forming 15 to 50 wt % based on the total weight of the composition, more particularly 20 to 30 wt %.

In another particular embodiment there is provided a water-ice composition comprising a particulate composition comprising a core containing a flavourant, colourant or other beneficial agent mentioned hereinabove, and a coating surrounding said core comprising a fat or wax, the coating forming 15 to 50 wt % based on the total weight of the composition, more particularly 20 to 30 wt %.

In another particular embodiment there is provided a sorbet composition comprising a particulate composition comprising a core containing a flavourant, colourant or other beneficial agent mentioned hereinabove, and a coating surrounding said core comprising a fat or wax, the coating forming 15 to 50 wt % based on the total weight of the composition, more particularly 20 to 30 wt %.

In another aspect there is provided a method of preparing a frozen confectionary product comprising the step of adding to said product a particulate composition as hereinabove described.

Ice cream and sorbet preparation is well known in the art. In a typical process a base is prepared by the admixture of ingredients that may include water, fats, syrups, proteins, gums, stabilisers, emulsifiers, sweeteners, and any flavour and flavour enhancers that might be required to be added to the base. This base is then typically pasteurised according to techniques well known in the art. Thereafter, the base is homogenised, e.g. using a high pressure homogenisation apparatus at pressures up to 3000 psi. This is followed by an aging step whereby the base is held at a temperature of around 4 degrees centigrade for a period of anywhere between 4 to 24 hours. After aging, the base is further cooled to a temperature of around minus 5 degrees centigrade before it is extruded into vessels for storage.

It is possible to add particulate compositions at any stage during the manufacturing process, particularly if it is deemed advantageous to do so. For example, introducing particles during freezing of the base, may create nucleation sites that can promote ice-crystal formation. On the other hand, of course, the earlier the particulate composition is introduced into the base, the greater the number of process steps will be performed on the composition and so the risk of leakage from the composition increases.

Particularly if the particulate compositions contain an ethyl cellulose coating, in a process of making an ice cream or sorbet, the particulate composition may be added prior to the extrusion step. More particularly, the composition may be added anywhere between 5 minutes and 4 hours prior to extrusion.

In another particular embodiment, in a process of making an ice cream or a sorbet, the particulate composition containing gelatine, fat or wax coating is added to the base pre-extrusion when the coating weight is not less than about 30 wt %. When the same coatings have a weight less than about 30 wt %, the particulate composition may be added post-extrusion.

Processes of making water-ice are well known in the art. In a typical procedure, a water-ice base is usually prepared by admixing water, sugars, flavours, acidulants, such as citric acid, and any other ingredients that are desired to be incorporated into the base. The mixture is then heated to a temperature of approximately 85 degrees centigrade to ensure the mixture is hydrated, before being cooled to about 5 degrees centigrade. Thereafter, the mixture is poured into moulds and flash-cooled, typically in a brine bath at a temperature of about minus 40 degrees centigrade.

In a particular embodiment, there is provided a process of making water-ice, wherein a particulate composition comprising an ethyl cellulose coating, in particular having a coating weight of 1 to 15 wt %, more particularly 3.5 to 10 wt %, is added to the mixture after cooling to 5 degrees centigrade and before flash cooling.

In another aspect, the use of a particulate composition as hereinabove defined is provided, particularly a particulate composition comprising an ethyl cellulose coating in a frozen confectionary product. The use of such particulate compositions can be in order to introduce discrete points of colour throughout the confectionary product. The compositions can also be used to create flavour effects whereby different flavours can be released according to different release kinetics. This can be achieved by using at least two different populations of particulate composition having different entrapped flavours and/or different coatings.

The embodiments are further illustrated with reference to the following non-limiting examples.

### EXAMPLE 1

An ice cream base was prepared by admixing 8 parts coconut oil (Akoline); 7 parts skimmed milk powder; 3 parts Esprion 300 (wpc); 12 parts sucrose; 4 parts maltodextrin; 0.5 part Stabiliser (Sherex ic9238); 0.005 part colourant (vegex nc 2c ws); and 65.495 parts water.

The solids were added to the water and mixed at 40 degrees centigrade with stirring. Thereafter the mixture was homogenised at 70 degrees centigrade and 180/50 bar. The homogenate was pasteurised at 82 degrees centigrade for 30 seconds and then allowed to cool to 4 degrees centigrade. The homogenate was allowed to age over night at 4 degrees centigrade. The ice cream mix was frozen in a batch ice cream machine.

A particulate compositions comprising flavourant and colourant and with 3.5 wt % ethyl cellulose coating was added to the ice cream pre-extrusion.

Upon extrusion there was no visible leaching of colourant from the particulate composition into the matrix. Similarly, the taste of the ice cream matrix was not contaminated with any flavourant leaching from the composition. Furthermore, after 14 days storage, there was no visual or taste alteration to the ice cream.

### EXAMPLE 2

A water-ice composition was prepared from the admixture of 777 parts water; 20 parts maltodextrin; 3 parts stabiliser (Sherex IC9559); and 200 parts sugar.

This mixture was heated to 85 degrees centigrade for 5 minutes to ensure hydration, before being allowed to cool to 5 degrees centigrade. A particulate composition containing a coating of ethyl cellulose (15 wt %) was added at 0.5%. The mixture was then shock frozen to a temperature of minus 35 degrees centigrade.

No discernable leakage was detected and distribution of the particles throughout the water-ice was good. The water-ice was stored for 2 weeks and once again no discernable leakage was detected as was distribution.

The embodiments described above and the preceding examples, are for the purpose of illustration only. The embodiments are not only in the alternative, but can be combined.

1. A frozen confectionary product comprising a particulate composition comprising a core containing a flavourant, flavour-enhancing agent ingredient, colourant or other beneficial ingredient, and one or more coatings around said core, wherein said coatings comprise gelatine, a fat or wax, ethyl cellulose or mixtures thereof.

2. The product according to claim 1 selected from the group consisting of ice cream, water-ice and sorbet.

3. The product according to claim 1 wherein the coating weight is 0.5 to 50 wt % of the particulate composition.

4. The product according to claim 1 wherein the coating is ethyl cellulose and the coating weight is 1 to 20 wt %.

5. The ice cream product according to claim 2 comprising a particulate composition comprising a core containing a flavourant, flavour-enhancing agent ingredient, colourant or other beneficial ingredient, and one or more coatings around said core, wherein said coating comprises ethyl cellulose and the coating weight is 1 to 15 wt %.

6. The water-ice product according to claim 2 comprising a particulate composition comprising a core containing a flavourant, flavour-enhancing agent ingredient, colourant or other beneficial ingredient, and one or more coatings around said core, wherein said coating comprises ethyl cellulose and the coating weight is 1 to 15 wt %.

7. The sorbet product according to claim 2 wherein the coating comprises ethyl cellulose and the coating weight is 1 to 15 wt %.

8. The ice cream product according to claim 2, wherein the coating comprises gelatine and the coating weight is 20 to 30 wt %.

9. The water-ice product according to claim 2 wherein the coating comprises gelatine and the coating weight is 20 to 30 wt %.

10. The sorbet composition product according to claim 2 wherein the coating comprises gelatine and the coating weight is 20 to 30 wt %.

11. A method of preparing a frozen confectionary product comprising the step of adding to said product a particulate composition comprising a core containing a flavourant, flavour-enhancing agent ingredient, colourant or other beneficial ingredient, and one or more coatings around said core, wherein said coatings comprise gelatine, a fat or wax, ethyl cellulose or mixtures thereof.

12. The method according to claim 11 wherein the particulate composition contains said coating comprising ethyl cellulose and wherein the coating weight is from 1 to 15 wt %.

13. The method according to claim 12 wherein the confectionary product is ice cream and the coating weight is from 1 to 15 wt %.

14. The method according to claim 12 wherein the confectionary product is water-ice and the coating weight is from 1 to 15 wt %.
